(19) United States
(12) Patent Application Publication
(10) Pub. No.: US 2016/0176218 A1
(43) Pub. Date: Jun. 23, 2016

(54) REACTIVE TRADING CARDS

(71) Applicants: Jim McCafferty, Santa Ana, CA (US); Greg Leong, Santa Ana, CA (US)

(72) Inventors: Jim McCafferty, Santa Ana, CA (US); Greg Leong, Santa Ana, CA (US)

(21) Appl. No.: 14/879,054

(22) Filed: Oct. 8, 2015

Related U.S. Application Data
(60) Provisional application No. 62/061,143, filed on Oct. 8, 2014.

(51) Int. Cl. B42D 15/04

(52) U.S. Cl. CPC B42D 15/045

(57) ABSTRACT

A generally rectangular housing having a substantially thicker dimension than conventional playing cards has its thickness obscured by the use of angled facets along the upper and lower portions of each surrounding edge. The top portion of the playing card defines a rotating panel which is rotatably movable within the surrounding housing between alternate positions separated by one hundred eighty degrees. A spring and lock mechanism allows the rotating panel to be rotated against the spring force to a first position and locked in that first position. With the rotating panel in its first position, the exposed top surface of the panel is generally coextensive with the upper surface of the housing causing the apparatus to appear to be a planar trading card. The undersurface of the rotating panel supports a collapsed three-dimensional figure. The figure itself comprises a plurality of spring biased joints which are latched in their compacted position against the spring forces within the joints.

### CROSS REFERENCE TO RELATED APPLICATION

This application claims the benefit of and priority under 35 U.S.C. 119(e) of U.S. Provisional Patent Application No. 62/061,143 entitled REACTIVE TRADING CARDS, filed Oct. 8, 2014 in the name of Jim McCafferty and Greg Leong, the disclosure of which is incorporated herein by reference.

### FIELD OF THE INVENTION

This invention relates generally to trading cards and particularly to improvements in the entertainment and amusement value thereof.

### BACKGROUND OF THE INVENTION

Trading cards have proven to be a well known and long-running successful category of game and amusement apparatus. While the fabrication of trading cards varies somewhat, most generally provide a plurality of thin shaped planar cards typically adorned with various pictures, icons, symbols and so on. While playing cards have assumed a variety of shapes, the overwhelming majority of such cards are simply rectangular or square-shaped. The most common types of playing cards are formed of a relatively thick paper or cardboard material or, alternatively, a thin flexible plastic material may be utilized. In some instances, attempts have been made to fabricate metal card like apparatus with little general success. While the majority of trading cards exhibit value based upon the particular images which they bear, such as famous individuals, sports personalities, athletes and so on, others have additional value in their significance for playing and overriding game objective. Thus, in addition to merely collecting trading cards, practitioners in such overriding game play facilitate a continuing value or at least perception of value for the trading cards.

The long term popularity of trading cards has prompted practitioners in the toy and game arts to produce a virtually endless variety of trading cards. Unfortunately, despite such substantial efforts, trading cards seldom have a lasting play value beyond their appearance and collector's value.

There remains therefore a continuing and unresolved need in the art for more active and entertaining types of improved trading cards.

### SUMMARY OF THE INVENTION

Accordingly, it is a general object of the present invention to provide improved trading cards. It is a more particular object of the present invention to provide improved trading cards which exhibit enhanced value and reactive as well as interactive capabilities. The present invention provides a generally rectangular housing having a substantially thicker dimension than conventional playing cards. The thickness of the housing is obscured by the use of angled facets along the upper and lower portions of each surrounding edge. The top portion of the playing card defines a rotating panel which is rotatably movable within the surrounding housing between alternate positions separated by one hundred eighty degrees. A spring and lock mechanism allows the rotating panel to be rotated against the spring force to a first position and locked in that first position. With the rotating panel in its first position, the exposed top surface of the panel is generally coextensive with the upper surface of the housing causing the apparatus to appear to be a planar trading card. The undersurface of the rotating panel supports a collapsed three-dimensional figure. The figure itself comprises a plurality of spring biased joints which are latched in their compacted position against the spring forces within the joints. Thus, with the present invention reactive trading card resting upon a planar surface such as a table or the like, the apparatus resembles a generally rectangular relatively thin playing card structure. When the trading card receives an impact sufficient to release the latch mechanism restraining the rotating panel in its upwardly facing position, the spring force operative upon the rotating panel causes it to rapidly rotate one hundred eighty degrees to an alternate position in which the bottom surface supporting the compacted figure now points upward and assumes the position of the upper surface of the playing card. Concurrently, as the impact releases the rotating panel for rapid rotation, the restraint upon the spring-biased joints of the compacted figure is also released and under the urging of a plurality of joint springs, the compacted figure transforms to a raised extended configuration.

In accordance with an important aspect of the invention, the rotational movement switching the position of the rotating panel and the compacted figure occurs quickly and gives the appearance of a “magical” transformation of the trading card from its playing configuration to its sudden support of an extended three-dimensional figure poised upon the trading card surface. The inventive trading card may be returned to its previous configuration by simply compacting the figure against the rotating panel and thereafter rotating the panel back to its original position and allowing the latch mechanism to secure the rotating panel in a position which hides the compacted figure on its bottom side. The inventive trading card may utilize a variety of types of figures and other objects to provide dramatic and exciting effects as the rotating panel quickly rotates upon impact.

### BRIEF DESCRIPTION OF THE DRAWINGS

The features of the present invention, which are believed to be novel, are set forth with particularity in the appended claims. The invention, together with further objects and advantages thereof, may best be understood by reference to the following description taken in conjunction with the accompanying drawings, in the several figures of which like reference numerals identify like elements and in which:

FIG. 1 set forth a perspective view of the present invention reactive trading card in its cocked position in which the expandable figure is concealed;

FIG. 2 sets forth a perspective view of the present invention reactive trading cards in its released configuration in which the previously compacted figure has expanded and transformed;

FIG. 3 sets forth a bottom perspective view of the present invention reactive trading card in its cocked position showing the compacted figure;

FIG. 4 sets forth an additional bottom perspective view of the present invention reactive trading card in its cocked configuration;

FIG. 5 sets forth a section view of the present invention reactive trading card taken along section lines 5-5 in FIG. 3;

FIGS. 6 through 14 set forth sequential top perspective views of the present invention reactive trading card transforming from the cocked configuration of FIG. 6 to the released configuration of FIG. 14;

FIG. 15 sets forth a bottom view of the rotating panel latch mechanism in the locked position;

FIG. 16 sets forth a bottom view of the latch mechanism in its released position;

FIG. 17 sets forth a simplified bottom view of the present invention reactive trading card in a cocked position;

FIG. 18 sets forth a perspective view of an alternate embodiment of the present invention reactive trading cards showing the figure latch;

FIGS. 19A through 19F set forth sequential views of the alternate embodiment of FIG. 18 as the panel rotates;

FIG. 20 sets forth a front view of the alternate embodiment shown in FIG. 18 having the figure standing;

FIGS. 21, 22 and 23 set forth sequential top views of the alternate embodiment of FIG. 18 showing the panel transitioning from its closed position to its open;

FIG. 24 sets forth a perspective view of a further alternate embodiment of the present invention reactive trading card showing a removable figure; and

FIG. 25 sets forth a perspective assembly view of the of the alternate embodiment of FIG. 24.

### DESCRIPTION OF THE PERFERRED EMBODIMENTS

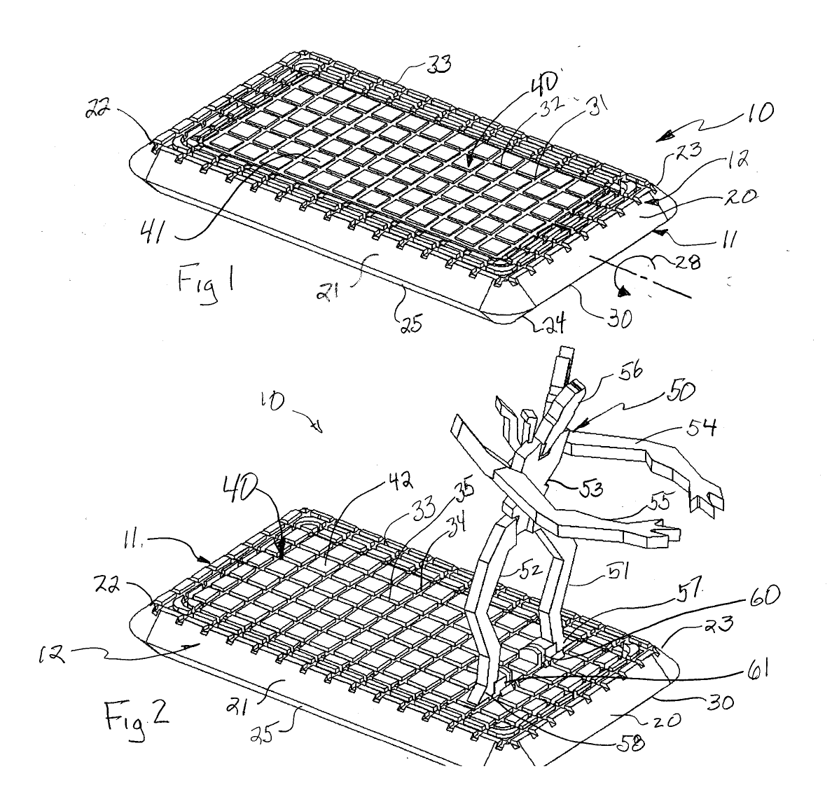

FIG. 1 sets forth a top perspective view of a reactive trading card constructed in accordance with the present invention and generally referenced by numeral 10. Trading card 10 includes a housing 11 having a generally rectangular frame 12. Frame 12 supports a plurality of angled upper facets 20, 21, 22 and 23 on each respective side of its rectangular shape. As is better seen in FIG. 3, frame 12 of housing 11 further defines a plurality of lower facets 24, 25, 26 and 27 upwardly angled to meet facets 20 through 23 respectively. An edge 30 extends around the periphery of frame 12 at the junction of upper facets 20 through 23 and lower facets 24 through 27. The extension of facets 20 through 23 downwardly from the upper portion of frame 12 and the extension upwardly of facets 24 through 27 from the bottom portion of frame 12 produces a sharp edge 30 surrounding frame 12 and providing a thinner appearance for the present invention reactive trading card.

In accordance with an important aspect of the present invention, reactive trading card 10 further includes a rotating panel 40 which as is better seen below in FIG. 17 is rotatably supported within the center aperture of frame 12. Rotating frame 40 defines a grid pattern comprised of a plurality of generally parallel left to right extending grooves 31 and a plurality of generally parallel top to bottom grooves 30. The result is a grid pattern formed of generally equally sized square elements. Thus, rotating panel 40 includes a top surface 41 which supports groove 31 and 32 and the resulting grid pattern formed thereon.

Frame 12 further defines a plurality of grooves 33 which define a generally grid-like like upper surface for frame 12 surrounding top surface 41 of rotating panel 40. The function of grooves 33 and the grid-like pattern provided by left to right grooves 31 and top to bottom grooves 32 formed on top surface 41 of rotating panel 40 is to obscure the separation of rotating panel 40 from frame 12. Ideally, the gap between rotating panel 41 and frame 12 is virtually unseen as reactive trading card 10 is configured in the cocked position shown in FIG. 1. The preferred appearance of reactive trading card 10 is that of a simple rectangular housing which is similar to a relatively thick conventional trading card.

FIG. 2 sets forth a perspective view of reactive trading card 10 showing the trading card in a released configuration exposing bottom surface 42 of rotating panel 40 and further exposing a compactable FIG. 50 in its expanded configuration. As described above, reactive trading card 10 includes a housing 11 having a generally rectangular frame 12, the upper surface of which defines a plurality of grid defining grooves 33. As is also described above, frame 12 of housing 11 defines a plurality of downwardly angled facets 20 through 23 and upwardly angled facets 24 through 27 which meet to form a surrounding sharp edge 30 which generally encircles frame 12.

By means set forth below in greater detail, reactive trading card 10 has assumed the release configuration in FIG. 2 characterized by the expanded configuration of a compactable FIG. 50. The process by which this transformation occurs is set forth below in greater detail. However, suffice it to note here that the released configuration shown in FIG. 2 is attained by allowing rotating panel 40 to rotate one hundred and eighty degrees from the configuration shown in FIG. 1 whereby a bottom surface 42 of rotating panel 40 is now upwardly facing within frame 12. It will be noted that bottom surface 42 includes a plurality of left to right grooves 34 and a plurality of top to bottom grooves 35 producing a grid-like configuration substantially identical to the configuration shown on top surface 41 (seen in FIG. 1). Bottom surface 42 of rotating panel 40 differs from top surface 41 in that it supports a pair of pivotal attachments 60 and 61. Pivotal attachments 60 and 61 are utilized in securing FIG. 50 upon bottom surface 42.

FIG. 50 is providing merely for illustration. It will be apparent to those skilled in the art from the descriptions and figures which follow that a virtually endless variety of figures may be provided in place of FIG. 50 to perform in a similar fashion. The essential function of FIG. 50 is that it be compactable through the articulation of a plurality of limb and body joints to transform from the expanded configuration shown in FIG. 2 to the compacted configuration shown in FIGS. 3 through 5 described below.

More specifically, FIG. 50 presents a substantially “human-like” figure in the illustration of FIG. 2. Thus, FIG. 50 includes a pair of legs 51 and 52 pivotally joined to a body 53. Body 53 in turn supports articulated arms 54 and 55 as well as head 56. Legs 51 and 52 terminate at their lower portion in feet 57 and 58. The latter are pivotally joined to pivots 60 and 61 respectively to allow the pivoting of legs 51 and 52 downwardly upon bottom surface 42 as FIG. 50 is placed in its compacted configuration. In the preferred fabrication of the present invention, the articulation of FIG. 50 includes a plurality of spring biased joints between articulated members which allow FIG. 50 to be configured in the compacted configuration shown in FIG. 3 by rotation against the joint springs. A simple friction latch at each compacted configuration of the joints of FIG. 50 enables FIG. 50 to be transformed from the expanded configuration shown in FIG. 2 to the compacted configuration shown in FIG. 3.

Thus with concurrent reference to FIGS. 1 and 2, FIG. 1 shows reactive trading card 10 in its cocked position in which rotating panel 40 presents top surface 41 and conceals FIG. 50 on the underside thereof within housing 11 as shown below in FIGS. 3 through 5. FIG. 2 shows the result of rotation of rotating panel 40 in the counterclockwise direction indicated by arrow 28 which switches top surface 41 and bottom surface 42 exposing FIG. 40 which springs to its expanded configuration during the panel rotation. The result is a magical appearing transformation which is nearly invisible to the eye when reactive trading card 10 receives a triggering impact. The use of identical grid patterns on top surface 41 and bottom surface 42 of rotating panel 40 enhances this magical appearance in that the rapid rotation of rotating panel 40 is, for the most part, not visible to the eye. Upon impact, reactive trading card 10 is jolted by the rapid rotation of rotating panel 40 as the transfiguration occurs. This further enhances the magical appearance of the transformation from the cocked position shown in FIG. 1 to the expanded configuration shown in FIG. 2.

FIG. 3 sets forth a bottom perspective view of reactive trading card 10 showing FIG. 50 in its compacted configuration and showing reactive trading card 10 in its cocked configuration.

As described above, reactive trading card 10 includes a generally rectangular housing 11 having a correspondingly rectangular surrounding frame 12. Frame 12 includes a plurality of angled facets 20 through 23 extending from the top surface thereof and a plurality of extending facets 24 through 27 extending from the lower surface thereof. As is also described above, facets 20 through 23 and 24 through 27 join to form an edge 30 about the periphery of frame 12. A rotating panel 40 is rotatably supported within frame 12 by a pair of pins 47 and 48 which provide axles for rotation of panel 40. Panel 40 further defines a bottom surface 42 upon which compactable FIG. 50 is supported. FIG. 50 is secured to bottom surface 42 by a pair of pivots 60 and 61 as shown above in FIG. 2. Frame 12 further defines a recess 66 extending upwardly from the lower edge of frame 12 to define a space within which compactable FIG. 50 is received. Recess 66 further defines a rectangular aperture 65 surrounding rotating panel 40. A generally flat surface 67 extends from aperture 65 to the wall portion of recess 66.

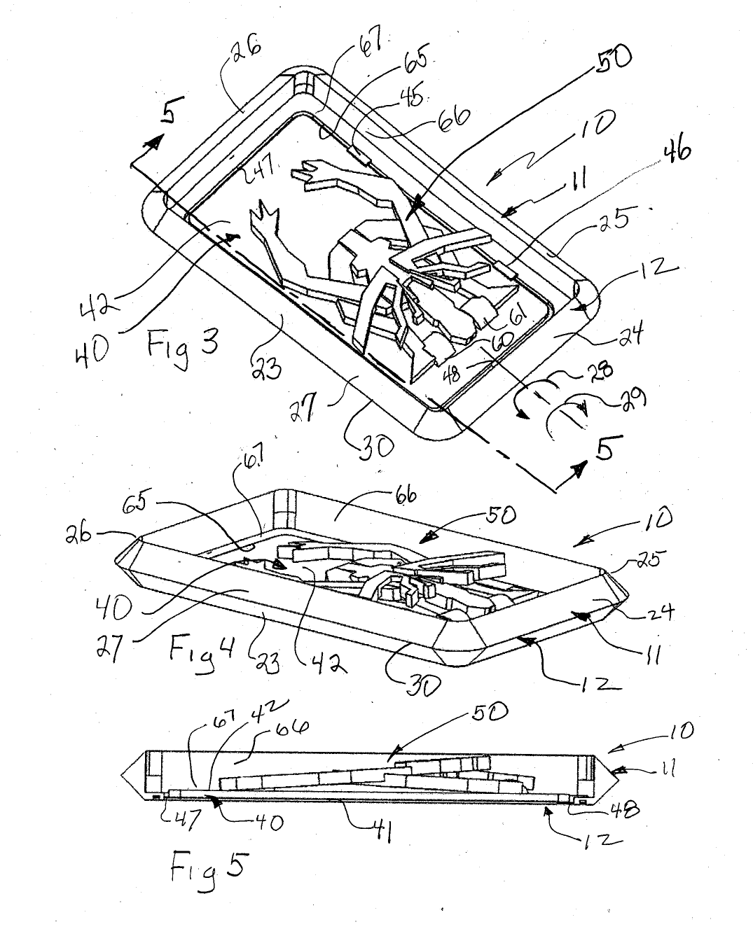

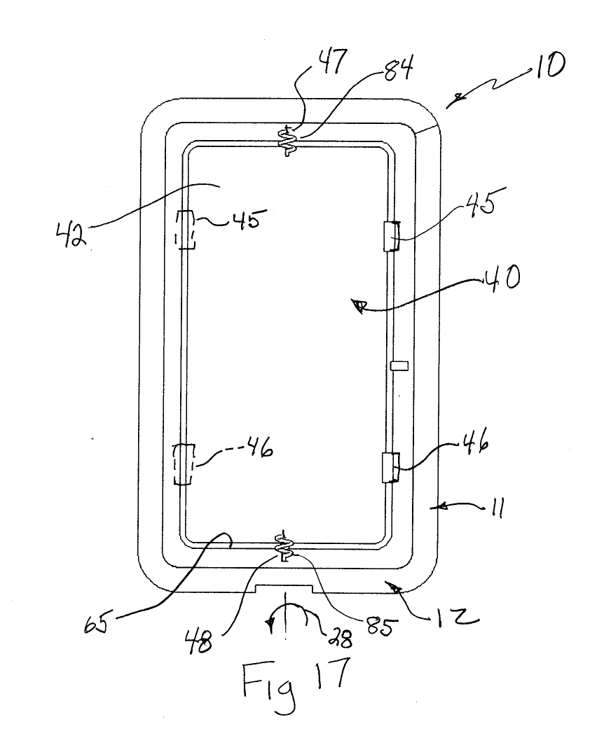

As is set forth below in greater detail, rotating panel 40 is coupled to a pair of springs (seen in FIG. 17) at the top and bottom portion thereof. The springs coupled to rotating panel 40 urge rotation of panel 40 in the counterclockwise direction indicated by arrow 28. Bottom surface 42 of rotating panel 40 includes a pair of stops 45 and 46 which extend outwardly from bottom surface 42. Stops 45 and 46 prevent rotation of rotating panel 40 in the direction indicated by arrow 29. A latch mechanism (seen in FIGS. 15 and 16) and described below is omitted from FIGS. 2 and 3. While the operation of the latch mechanism operative upon stops 45 and 46 is set forth below in conjunction with FIGS. 15 and 16 in greater detail, it has been omitted from FIGS. 3 and 4 to enable discussion of the rotation of rotating panel 40. Suffice it to note here that the extension of stops 45 and 46 cooperate with surface 67 to limit the clockwise rotation of rotating panel 40 in the direction indicated by arrow 29 and to limit the counterclockwise rotation of rotating panel 40 in the direction indicated by arrow 28. In this manner, stops 45 and 46 cooperate with surface 67 to limit the rotation of rotating panel 40 between the two configurations described above as the cocked configuration and the released configuration. In the configuration of reactive trading card 10 shown in FIG. 3, it will be understood that the operative impact responsive latch set forth below in FIG. 15 is operative upon stop 46 to secure rotating panel 40 in the cocked position shown in FIG. 3.

FIG. 4 set forth a bottom perspective view of reactive trading card 10 which better illustrates the enclosure of compactable FIG. 50 within recess 66 in the cocked configuration. It will be noted in FIG. 4 that FIG. 50 in its compacted configuration fits entirely within recess 66. Thus, when reactive trading card 10 is placed upon a flat surface such as a table or the like, FIG. 50 is entirely enclosed beneath rotating panel 40. As described above, reactive trading card 10 includes a generally rectangular housing 11 having a correspondingly rectangular surrounding frame 12. Frame 12 includes a plurality of angled facets 20 through 23 extending from the top surface thereof and a plurality of extending facets 24 through 27 extending from the lower surface thereof.

As is also described above, facets 20 through 23 and 24 through 27 join to form an edge 30 about the periphery of frame 12. A rotating panel 40 is rotatably supported within frame 12 by a pair of pins 47 and 48 which provide axles for rotation of panel 40. Panel 40 further defines a bottom surface 42 upon which compactable FIG. 50 is supported. FIG. 50 is secured to bottom surface 42 by a pair of pivots 60 and 61 as shown above in FIG. 2. Frame 12 further defines a recess 66 extending upwardly from the lower edge of frame 12 to define a space within which compactable FIG. 50 is received. Recess 66 further defines a rectangular aperture 65 surrounding rotating panel 40. A generally flat surface 67 extends from aperture 65 to the wall portion of recess 66.

It will be apparent to those skilled in the art that the captivity of FIG. 50 within recess 66 when reactive trading card 10 is placed upon a play surface such as a table further secures the compacted configuration of FIG. 50 during play patterns.

FIG. 5 sets forth a section view of reactive trading card 10 taken along section lines 5-5 in FIG. 3. Thus, FIG. 5 shows compactable figure in its compact configuration received within recess 66 of housing 11. Of importance to note is that in its compact configuration, FIG. 50 does not extend beyond the edge of recess 66. This allows reactive trading card 10 to be inverted to its upright position such as that shown in FIG. 1 and readily moved upon a play surface such as a table.

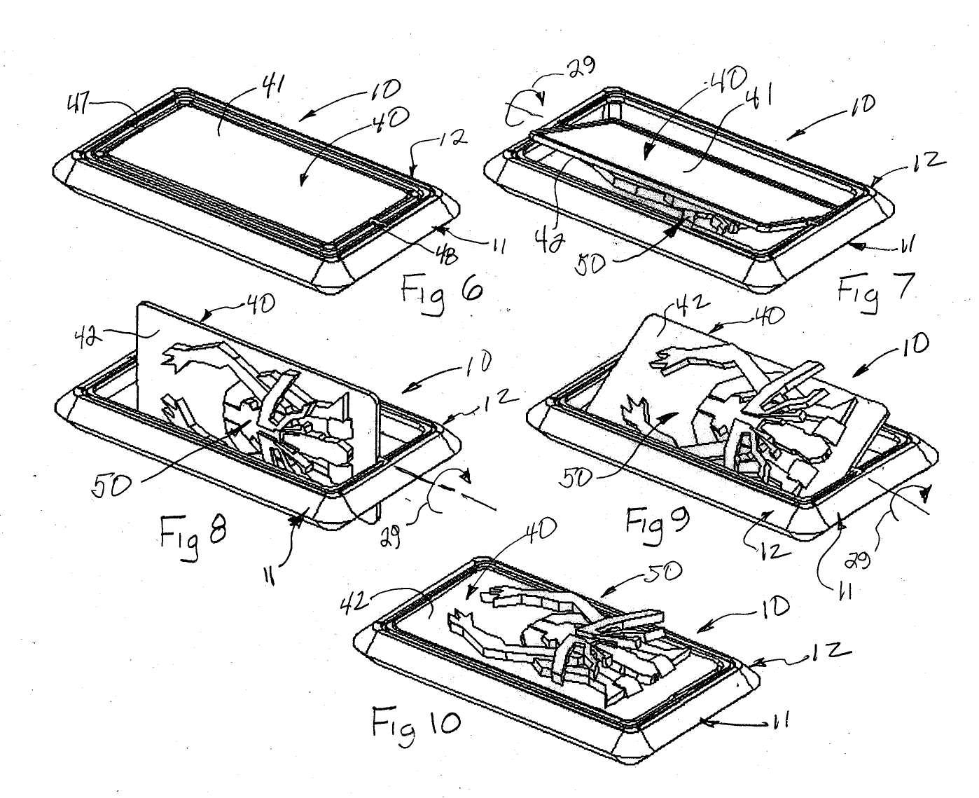

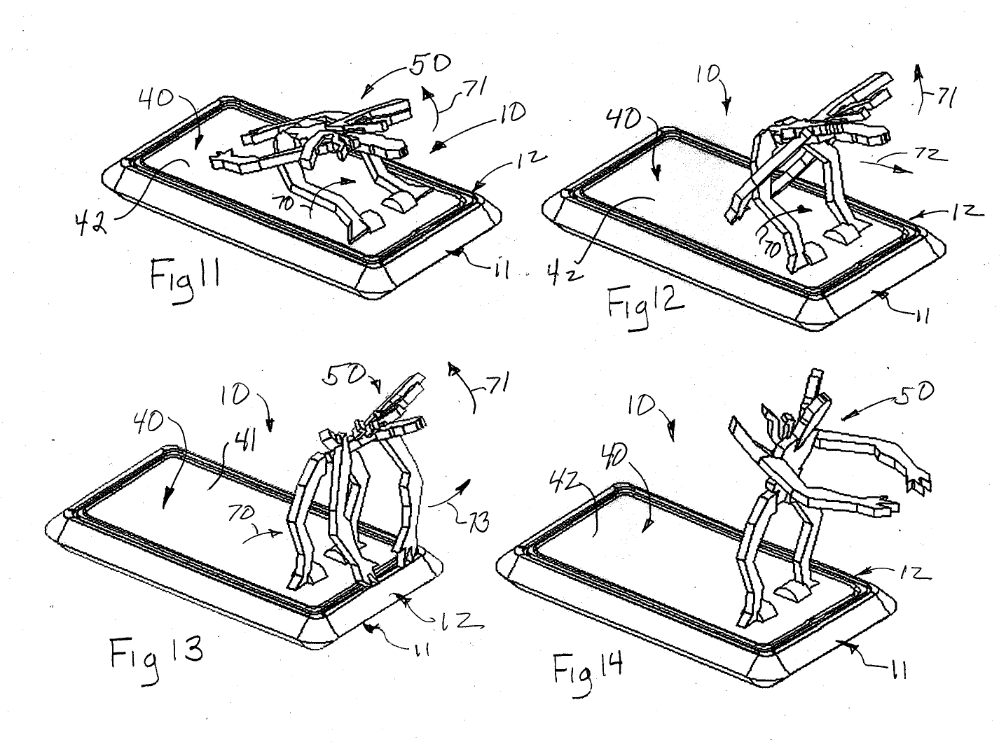

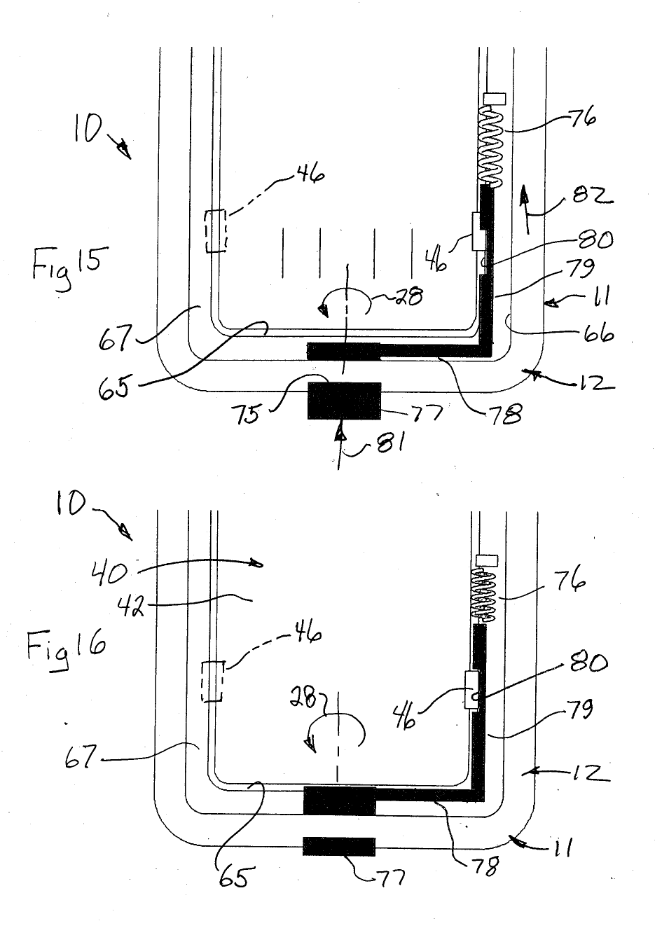

FIGS. 6 through 14 set forth sequential views of the present invention reactive trading card as it responds to an impact and transitions from the cocked configuration shown in FIG. 6 to eventually assume the released configuration shown in FIG. 14. For purposes of illustration, the figures set forth in FIGS. 6 through 14 are somewhat simplified in that various elements such as the grid-like configurations sets forth in FIGS. 1 and 2 above have been omitted for clarity. Thus, FIGS. 6 through 14 will be understood to provide somewhat simplified views by which the reader is able to follow the sequential movements of reactive trading card 10 as it responds to an impact and undergoes its transformation to the release configuration exposing FIG. 50. Thus, in FIGS. 6 through 14, there is shown reactive trading card 10 having a housing 11 which includes a frame 12 supporting a rotating panel 40 having an upper surface 41 and a lower surface 42. In accordance with the above-described structures, FIGS. 6 through 14 set forth the sequence of operation by which transition occurs in response to an impact. Accordingly, beginning with the initial configuration shown in FIG. 6, reactive trading card 10 is shown in its cocked configuration such as would be assumed at the beginning of game played. In this configuration, rotating panel 40 is position to expose top surface 41 within frame 12 of housing 11 and the reactive trading card assumes a generally planar appearance. Upon the initiation of a triggering impact, the reactive trading card of the present invention moves to FIG. 7 in which the rotation of rotating panel 40 has begun. In the example shown in FIGS. 6 through 14, rotating panel 40 undergoes a clockwise rotation indicated by arrow 29. It will be noted by return to FIG. 3 that the above-described embodiments rotate in the opposite direction. Thus, it will be clear that rotating panel 40 may be configured to rotate in either direction as a matter of design choice. As rotating panel 40 continues to rotate in the clockwise direction indicated by arrow 29, reactive trading card 10 moves to the configuration shown in FIG. 8 in which rotating panel 40 is now vertical within frame 12 of housing 11 exposing FIG. 50 and lifting reactive trading card from the play surface. Thereafter, as rotating panel 40 continues to rotate, reactive trading card 10 assumes the configuration shown in FIG. 9 in which further rotation in the direction of arrow 29 of rotating panel 40 is occurring. Thereafter, as shown in FIG. 10, the rotation of rotating panel 40 is complete and bottom surface 42 is now positioned to face upwardly within frame 12. FIG. 50 is now fully exposed and reactive trading card 10 now rests again on the play surface. Once the rotation of rotating panel 40 is complete, reactive trading card 10 assumes the configuration shown in FIG. 11 in which further rotation of rotating panel 40 is precluded by the above-described stops 45 and 46 (seen in FIG. 3). Under the urging of spring force within the spring-driven joints of FIG. 50, FIG. 50 now begins to rise. Accordingly, the legs of FIG. 50 pivot upwardly from surface 42 in the direction indicated by arrow 70 as the body portion of FIG. 50 begins to pivot upwardly in the direction indicated by arrow 71. Thereafter, as is seen in FIG. 12, the position of rotating panel 40 is maintained as continued pivotal motion of FIG. 50 in the directions indicated by arrows 70 and 71 results in upward extension of the figure and movement in the direction indicated by arrow 72. In FIG. 13, the further rise of FIG. 50 is indicated as the figure's arms rise in the direction indicated by arrow 73 and rotation in the directions indicated by arrows 70 and 71 continues. Finally, at FIG. 14, the full transformation of reactive trading card 10 to the released configuration is shown. This configuration corresponds to the configuration shown above in FIG. 2 in which FIG. 50 has assumed its full vertical extension.

It will be apparent to those skilled in the art that reactive trading card 10 is returned to its cocked configuration by reverse order transformation starting at FIG. 14 and extending through FIGS. 13 through 6 to again resume the cocked configuration shown in FIG. 6 and shown above in FIG. 1.

FIGS. 15 and 16 set forth the operation of the latch mechanism which provides the impact response of the present invention reactive trading card. The operation of the latch shown in FIGS. 15 and 16 provides a release mechanism by which rotating panel 40 is released from its cocked position to rotate into its release position and thereby provide the above-described dramatic action by which FIG. 50 seemingly emerges from nowhere.

Reactive trading card 10 includes a housing 11 supporting a frame 12 within which a rotating panel 40 is supported. Rotating panel 40 is shown having surface 42 facing downwardly. Frame 12 defines an aperture 65 within which rotating panel 40 is rotatably supported. A stop 46 extends from panel 40 and overlies surface 67 of recess 66 formed in frame 12.

A latch mechanism includes a movable button 77 extending through an aperture 75 formed in frame 12. The interior end of button 77 supports a laterally extending arm 78 and an extending arm 79. Arm 79 is coupled to a spring 76, the remaining end of which is fixed upon surface 67. Arm 79 defines a notch 80 which is preferably sized to be larger than stop 46.

In the latched position shown in FIG. 15, spring 76 urges arm 79 and arm 78 to force button 77 outwardly through aperture 75. As a result of this positioning, notch 80 of arm 79 obstructs the movement of stop 46. Accordingly, stop 46 prevents rotation of rotating panel 40. The latch mechanism shown is operated by a force against button 77 in the direction indicated by arrow 81. This force is transmitted by arm 78 to move arm 79 against the force of spring 76 in the direction indicated by arrow 82.

FIG. 16 shows the position of the latch mechanism in response to a triggering force. This triggering force results from an impact against button 77.

Reactive trading card 10 includes a housing 11 supporting a frame 12 within which a rotating panel 40 is supported. Rotating panel 40 is shown having surface 42 facing downwardly. Frame 12 defines an aperture 65 within which rotating panel 40 is rotatably supported. A stop 46 extends from panel 40 and overlies surface 67 of recess 66 formed in frame 12.

A latch mechanism includes a movable button 77 extending through an aperture 75 formed in frame 12. The interior end of button 77 supports a laterally extending arm 78 and an extending arm 79. Arm 79 is coupled to a spring 76, the remaining end of which is fixed upon surface 67. Arm 79 defines a notch 80 which is preferably sized to be larger than stop 46.

The inward movement against spring 76 shown in FIG. 16 which overcomes the force of spring 76 positions notch 80 of arm 79 in alignment with stop 46. As a result, stop 46 is no longer obstructed by arm 79. As a result, the spring force operative upon rotating panel 40 is released and rotating panel 40 is free to rotate in the direction indicated by arrow 28. It will be apparent to those skilled in the art that while the latch mechanism shown in FIGS. 15 and 16 is illustrative of an operative latch, other latch mechanisms may be utilized to restrain the rotation of rotating panel 40 without departing from the spirit and scope of the invention.

FIG. 17 sets forth a simplified bottom view of reactive trading card 10 showing the positioning of a pair of springs 84 and 85 which are coupled between rotating panel 40 and frame 12 of housing 11. As described above, rotating panel 40 is rotatably supported within recess 66 of frame 12 such that rotating panel 40 is positioned within aperture 65 formed therein. A pair of stops 45 and 46 restrict further rotational motion of rotating panel 40. Springs 84 and 85 cooperate with pins 47 and 48 to urge rotation of rotating panel 40 in the direction indicated by arrow 29. This provides a spring force against rotating panel 40 which is resisted by the latch mechanism set forth above in FIGS. 15 and 16. It will be recalled that the above-described latch mechanism operates upon stop 46 to prevent rotation of rotating panel 40 in the direction indicated by arrow 28. It will also be noted that once the above-described latch has been released as set forth in FIG. 16, the force of springs 84 and 85 cause rotating panel 40 to rapidly rotate in the direction indicated by arrow 28. This rotation is limited by the contact of stops 45 and 46 at the opposite positions shown in phantom-line depiction in FIG. 17. Thus, stops 45 and 46 cooperate with surface 67 to limit the rotation of rotating panel 40 between the position shown in FIG. 17 and a one hundred eighty degree rotation.

FIG. 18 sets forth a perspective view of an alternate embodiment of the present invention reactive trading card generally referenced by numeral 90 showing an alternative figure latch. Trading card 90 is constructed in general accordance with the above described embodiments and functions in substantially the same manner. Trading card 90 includes a frame 91 within which a panel 100 is rotatably supported. A FIG. 92 is supported upon surface 105 of panel 100. A latch 95 includes a latch rod 93 having a catch 102 on one end and a finger end 101 on the other end. FIG. 92 defines a notch 93 which is engaged by catch 102 to secure FIG. 92 against surface 105 of panel 100. The operation of latch 95 is described below in greater detail. However, suffice it to note here that finger end 101 extends beyond the edge of panel 100. As will be seen, finger end 101 contacts frame 91 to release figure latch 95. Thus, it will become apparent that trading card 90 utilizes an alternative latch for restraining FIG. 92 but is, for the most part, substantially the same as the above described embodiments.

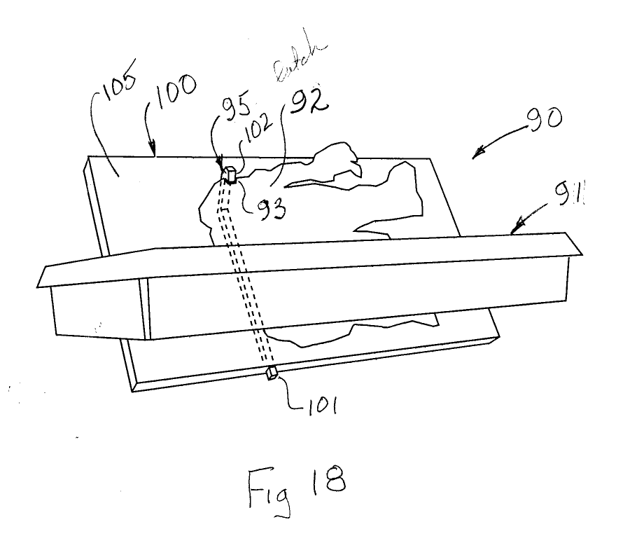

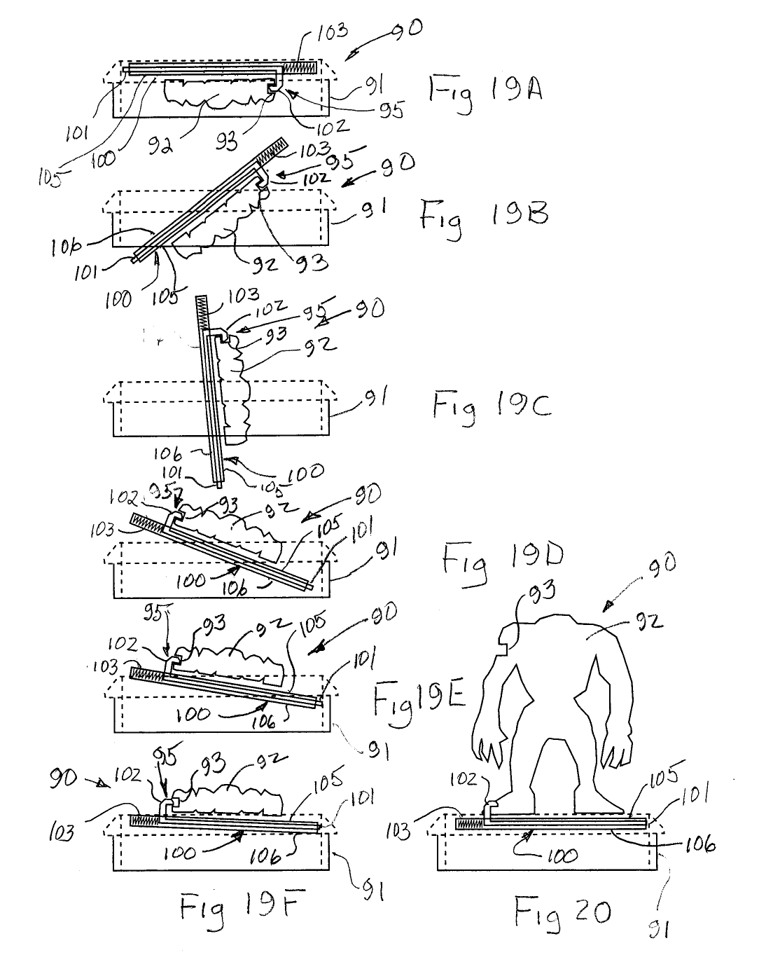

FIGS. 19A through 19F set forth sequential views of trading card 90 as panel 100 rotate. Thus, as described above, trading card 90 includes a frame 91 within which a panel 100 is rotatably supported. A FIG. 92 is supported upon surface 105 of panel 100. A latch 95 includes a latch rod 93 having a catch 102 on one end and a finger end 101 on the other end. FIG. 92 defines a notch 93 which is engaged by catch 102 to secure FIG. 92 against surface 105 of panel 100. FIG. 19A shows trading card 90 in its closed compacted configuration with FIG. 90 hidden on the underside of panel 100. At this point, panel latch 120 (seen in FIG. 21) restrains panel 100 against rotation and figure latch 95 restrains FIG. 92 against surface 105 of panel 100 by the engagement of catch 102 in notch 93. It will be noted that latch 95 is slightly off center on panel 100 and as a result, finger end 101 does not contact frame 91. By comparison, it will be noted in FIG. 19F below that once panel 100 rotates, finger end 101 is pushed inwardly by its contact with frame 91 thereby releasing figure latch 95.

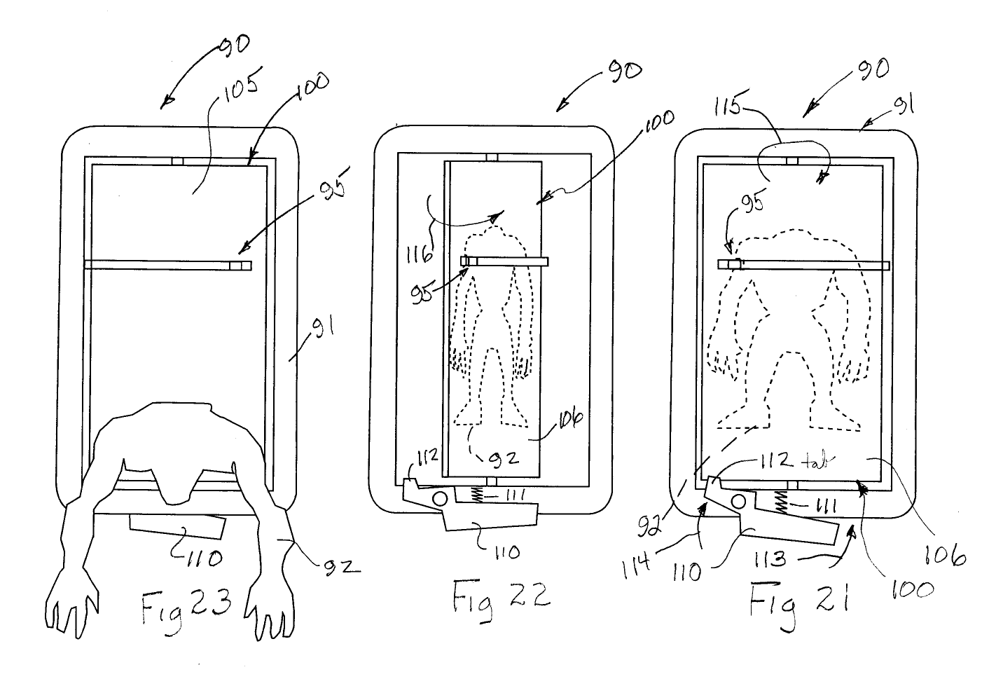

FIGS. 19B through 19 E show the rotation of panel 100 once panel latch 110 (seen in FIG. 21) is released. FIG. 19F shows the end of the panel rotation and, as is mentioned above, finger end 101 is pushed inwardly overcoming the force of spring 103 to release FIG. 92 allowing FIG. 92 to rise to the extended position shown in FIG. 20. Thus, FIG. 20 will be understood to set forth a front view of trading card 90 having panel 100 fully rotated and having FIG. 92 standing upright.

FIGS. 21, 22 and 23 set forth sequential top views of trading card 90 showing the panel transitioning from its closed position to its open and showing the operation of panel latch 110. As described above, trading card 90 includes a frame 91 within which a panel 100 is rotatably supported. A FIG. 92 is supported upon surface 105 of panel 100. A latch 95 includes a latch rod 93 having a catch 102 on one end and a finger end 101 on the other end. FIG. 92 defines a notch 93 which is engaged by catch 102 to secure FIG. 92 against surface 105 of panel 100. FIG. 19A shows trading card 90 in its closed compacted configuration with FIG. 90 hidden on the underside of panel 100. At this point, panel latch 120 (seen in FIG. 21) restrains panel 100 against rotation and figure latch 95 restrains FIG. 92 against surface 105 of panel 100 by the engagement of catch 102 in notch 93.

More specifically, FIG. 21 shows a panel latch 110 pivotally supported upon frame 91. Panel latch 91 includes a latch tab 112 which is urged by a spring 111 in the direction indicated by arrow 114. As panel latch 110 pivots in the direction indicated by arrow 114, latch tab 112 overlies surface 106 of panel 100. A spring (seen in FIG. 17) urges panel 1100 toward rotation in the direction indicated by arrow 115 which is restrained by latch tab 112.

FIG. 22 shows trading card 90 following the release of panel 100 as panel latch 110 is impacted in a manner that results in pivoting panel latch 110 in the direction indicated by arrow 113 (seen in FIG. 21). With latch tab 112 moved from panel 100, panel 100 rotates in the direction indicated by arrow 116. During this panel rotation, FIG. 92 continues to be restrained by figure latch 95.

FIG. 23 shows trading card 90 at the end of a panel rotation and following the release of FIG. 92 by the above described action of figure latch 95 as finger end 101 of latch 95 contacts frame 91.

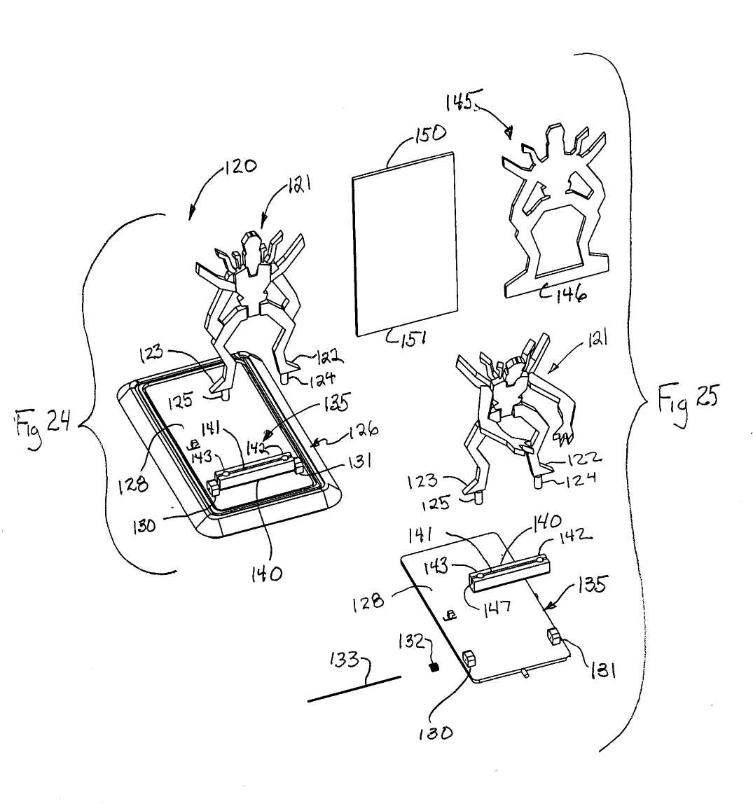

FIG. 24 sets forth a perspective view of a further alternate embodiment of the present invention reactive trading card, generally referenced by numeral 120, showing a removable figure generally referenced by numeral by numeral 121. Trading card 120 includes a housing 126 having a frame 127. A rotatable panel 135 is rotatably supported within frame 127 in the above described manner. Panel 135 supports a pair of bearings 130 and 131. A figure attachment 140 defines a slot 141 and a pair of peg receptacles 142 and 143. Figure attachment 140 further defines a transverse bore 147. As is better seen in FIG. 25, figure attachment 140 is pivotally supported between bearings 130 and 131 by an axle 133. A FIG. 121 includes legs 1122 and 123 having respective pegs 124 and 125. FIG. 121 is secured to figure attachment 140 by the cooperation of pegs 124 and 125 within peg receptacles 142 and 143 respectively. Thus, FIG. 121 is interchangeable with other similar figures or with a playing card, such as playing card 150 (shown in FIG. 25) or a silhouette figure such as FIG. 145 (also seen in FIG. 25). As a result, a variety of figures, cards or silhouette type figures may be interchanged within trading card 120 with the same performance as described above.

FIG. 25 sets forth a perspective assembly view of the of the alternate embodiment of FIG. 24. As described above, trading card 120 includes a housing 126 having a frame 127. A rotatable panel 135 is rotatably supported within frame 127 in the above described manner. Panel 135 supports a pair of bearings 130 and 131. A figure attachment 140 defines a slot 141 and a pair of peg receptacles 142 and 143. Figure attachment 140 further defines a transverse bore 147. As is better seen in FIG. 25, figure attachment 140 is pivotally supported between bearings 130 and 131 by an axle 133. A FIG. 121 includes legs 122 and 123 having respective pegs 124 and 125. FIG. 121 is secured to figure attachment 140 by the cooperation of pegs 124 and 125 within peg receptacles 142 and 143 respectively. Silhouette FIG. 145 includes a base 146 which is received within slot 141 to secure FIG. 145 to attachment 140. Similarly, card 150 defines a bottom edge 146 which also is received within slot 141 to secure card 150 to attachment 140. Accordingly, it will be recognized that the present invention reactive trading card is able to function with a variety of interchangeable figures in the novel manner set forth above.

What has been shown is a reactive trading card which provides an additional and improved play pattern by which the trading card becomes active and participates in game play activities in a dramatic fashion.

While particular embodiments of the invention have been shown and described, it will be obvious to those skilled in the art that changes and modifications may be made without departing from the invention in its broader aspects. Therefore, the aim in the appended claims is to cover all such changes and modifications as fall within the true spirit and scope of the invention.

That which is claimed is:

1. A reactive trading card comprising:
a housing defining an aperture and a surrounding frame;
a panel having a first side and a second side, said panel being rotatably supported within said frame and rotatable between a first position exposing said first surface while concealing said second surface within said aperture and a second position exposing said second surface while concealing said first surface within said aperture;
a spring coupled to said frame urging said panel toward said second position;
a releasable latch maintaining said panel in said first position and releasing said panel in response to an impact;
a figure having a plurality of articulated joints supported upon said second surface, said figure being configurable in a first compacted configuration and extendable to a second extended configuration upon said second surface; and
a plurality of joint spring latches coupled to said articulated joints releasably latching said joints in said first compacted configuration and having a spring urging said joint toward said second extended configuration,
said trading card initially configured to have said rotating panel latched in said first position with said figure in said first compacted configuration and upon receiving an impact, said panel rapidly rotating to said second position and said figure rising to said second extended position.

2. The reactive trading card set forth in claim 1 wherein said housing frame defines a first visible pattern surrounding said aperture and wherein said first surface of said rotating panel defines a second visible pattern that cooperates with said first visible pattern to obscure the separation between said frame and said rotating panel.

3. The reactive trading card set forth in claim 2 wherein said second surface defines said second visible pattern.

4. The reactive trading card set forth in claim 3 wherein said figure is pivotally joined to said second surface.

5. The reactive trading card set forth in claim 4 wherein said figure defines a body and supporting legs and wherein said legs each include a foot pivotally joining said legs to said second surface.

6. A reactive trading card comprising:
a housing defining an aperture and a surrounding frame;
a panel having a first side and a second side, said panel being rotatably supported within said frame and rotatable between a first position exposing said first surface while concealing said second surface within said aperture and a second position exposing said second surface while concealing said first surface within said aperture;
a spring coupled to said frame urging said panel toward said second position;
a releasable latch maintaining said panel in said first position and releasing said panel in response to an impact; and
a figure supported upon said second surface,
said trading card initially configured to have said rotating panel latched in said first position with said figure in said first compacted configuration and upon receiving an impact, said panel rapidly rotating to said second position and said figure rising to said second extended position.

7. The reactive trading card set forth in claim 6 wherein said second surface includes a pivoting figure support defining a first figure attachment and wherein said figure includes a second figure attachment cooperating with said first figure attachment to removably secure said figure to said pivoting figure support.

8. The reactive trading card set forth in claim 7 wherein said figure is a substantially flat playing card.

9. The reactive trading card set forth in claim 7 wherein said figure is a substantially flat silhouette cut out of a figure.

10. The reactive trading card set forth in claim 7 wherein said figure is a sculptured silhouette of a figure.

11. A reactive trading card comprising:
a housing defining an aperture and a surrounding frame;
a panel having a first side and a second side, said panel being rotatably supported within said frame and rotatable between a first position exposing said first surface while concealing said second surface within said aperture and a second position exposing said second surface while concealing said first surface within said aperture;
a spring coupled to said frame urging said panel toward said second position;
a releasable latch maintaining said panel in said first position and releasing said panel in response to an impact;
a figure having a plurality of articulated joints, said figure supported upon said second surface and said figure being configurable in a first compacted configuration and extendable to a second extended configuration upon said second surface,
said trading card initially configured to have said rotating panel latched in said first position with said figure in said first compacted configuration and upon receiving an impact, said panel rapidly rotating to said second position and said figure rising to said second extended position.

12. The reactive trading card set forth in claim 11 wherein said housing frame defines a first visible pattern surrounding said aperture and wherein said first surface of said rotating panel defines a second visible pattern that cooperates with said first visible pattern to obscure the separation between said frame and said rotating panel.

13. The reactive trading card set forth in claim 12 wherein said second surface defines said second visible pattern.

14. The reactive trading card set forth in claim 13 wherein said figure is pivotally joined to said second surface.

15. The reactive trading card set forth in claim 12 wherein said second surface includes a pivoting figure support defining a first figure attachment and wherein said figure includes a second figure attachment cooperating with said first figure attachment to removably secure said figure to said pivoting figure support.

16. The reactive trading card set forth in claim 15 further including a plurality of figures each having said second figure attachment cooperating with said first figure attachment to removably and interchangeably secure each of said figures to said pivoting figure support.
